(19) United States
(12) Patent Application Publication
(10) Pub. No.: US 2013/0063259 A1
(43) Pub. Date: Mar. 14, 2013

(54) Wireless Radio Frequency Switch Controller

(71) Applicants: Mark Kramer, Castle Rock, CO (US); Wilfred Tucker, Centennial, CO (US); John Sample, Centennial, CO (US); Christopher Bermel, Denver, CO (US)

(72) Inventors: Mark Kramer, Castle Rock, CO (US); Wilfred Tucker, Centennial, CO (US); John Sample, Centennial, CO (US); Christopher Bermel, Denver, CO (US)

(21) Appl. No.: 13/607,945

(22) Filed: Sep. 10, 2012

Related U.S. Application Data
(60) Provisional application No. 61/533,203, filed on Sep. 10, 2011.

(51) Int. Cl. G08C 19/16; G08B 1/08

(52) U.S. Cl. 340/539.11; 340/12.5

(57) ABSTRACT

A wireless radio frequency switch controller that requires no batteries is disclosed, as is a method for interacting between the wireless radio frequency switch controller and a Bluetooth device. The wireless radio frequency switch controller taps into the existing garage door control wiring and uses capacitors to retain power (voltage and current), which is a form of energy harvesting. The Bluetooth device interaction causes a digital controlled switch such as a transistor, solid state switch, or electrochemical relay, which operates the desired garage door motor thereby opening and closing the garage door. Additionally, the wireless radio frequency switch controller may operate in conjunction with different parent systems such as thermostats, doorbells, security systems, or the like.

### CROSS REFERENCE TO RELATED APPLICATIONS

This application is a non-provisional of U.S. Provisional Application Ser. No. 61/533, 203 filed on Sep. 10, 2011, which is herein incorporated by reference in its entirety.

### FIELD

This invention relates to a wireless radio frequency switch controller and a method of using the described invention.

### BACKGROUND

Various garage doors and other artificial, electronically controlled barriers have been used for many years to protect the owner's contents therein. They provide a security measure against the outside world and are accessible only to those who possess the correct means to operate the mechanism.

The method of controlling these security doors is achieved by a remote radio frequency controller, which interacts with the receiver that is adapted to receive the wireless command signal. The problem arises when the controller, which is battery operated, no longer functions. This is due to the depletion of the battery source and the need for new batteries. Batteries cost money and are not easy to dispose, nor are they environmentally friendly. With the push to be more environmentally friendly in the context of technology; there is a problem for which a solution is desirable.

In addition, various universal opening mechanisms consisting of a receiver and transmitter require some labor in the installation process. A receiver must be connected in some form to the mechanism by which the door operates or installed elsewhere nearby. This proximity problem poses an issue because the height and placement of these operating mechanisms are not within the reach of most individuals. Most often, a ladder or other means, and other proper tools are required for proper installation. When these are not readily accessible, the individual must have another person perform the installation which can end up costing the customer more money.

### SUMMARY

The present invention solves these problems by using an adapter that fits and works with an existing system with no need for undue manual installation or the use of hand tools. In addition, the system is battery free, making it more cost effective and the safer for the environment.

According to one aspect of the invention, there is a low energy Bluetooth device that operates in conjunction with the wireless radio frequency switch controller once applied as intended. The wireless radio frequency switch controller comprises a printed circuit board (PCB) contained within an external housing, the external housing having a means for mounting the PCB. In addition, the external housing has at least one contact penetrating clip. The wireless radio frequency switch controller may also have an internal real time clock, at least one light emitting diode (LED), and at least one depressible switch. The real time clock permits the electronic opening or closing of a garage door or barrier at predetermined times, and can time stamp the position of the door at any given time. Additionally, an accelerometer may be placed on the existing garage door.

The wireless radio frequency switch controller quickly snaps onto the existing wiring of the garage door and is operational from that point forward. The built-in software automatically determines the polarity of the signal and ground of the existing garage door wiring. The wireless radiofrequency switch controller measures a motor voltage change over a low volt direct current wiring of the existing garage door. The low energy Bluetooth device operates in communication with the wireless radio frequency switch controller. The capacitors contained within the wireless radio frequency switch controller store electrical energy from the existing wiring to use in small bursts when one attempts to interact with the invention, thereby opening and closing the existing door.

A method of using a wireless radio frequency switch controller comprises attaching an external housing to existing garage door wiring, and depressing the contact penetrating clip(s) into the existing garage door wiring. From there, one sends an ISM wireless radio spectrum signal to the wireless radio frequency switch controller. The ISM signal may be a Bluetooth low energy, ANT, or Zigbee protocol implementing 128-bit security encryption.

In another aspect of the invention, the invention functions as described but rather in conjunction with another parent apparatus such as a thermostat, doorbell, security system, or other system that operates over a range of about 6Vdc to about 40Vdc.

These and other embodiments will be better understood in conjunction with the drawings and descriptions that follow.

### BRIEF DESCRIPTION OF THE DRAWINGS

Preferred embodiments of the invention will now be described, by way of example, with reference to the accompanying drawings, in which:

FIG. 1 is a perspective view of the desired application and fitting of a preferred embodiment of the invention.

FIG. 2 is an interior view of the components demonstrating the interior apparatus and the printed circuit board.

FIG. 3 is an underside view of the exterior shell of the protective housing.

FIG. 4 is a perspective view of a preferred embodiment with the contact penetrating clip removed.

FIG. 5 is an underside view of the contact penetrating clip.

FIG. 6 is an enlarged cross-sectional view taken along line 5-1 in FIG. 5.

### DETAILED DESCRIPTION

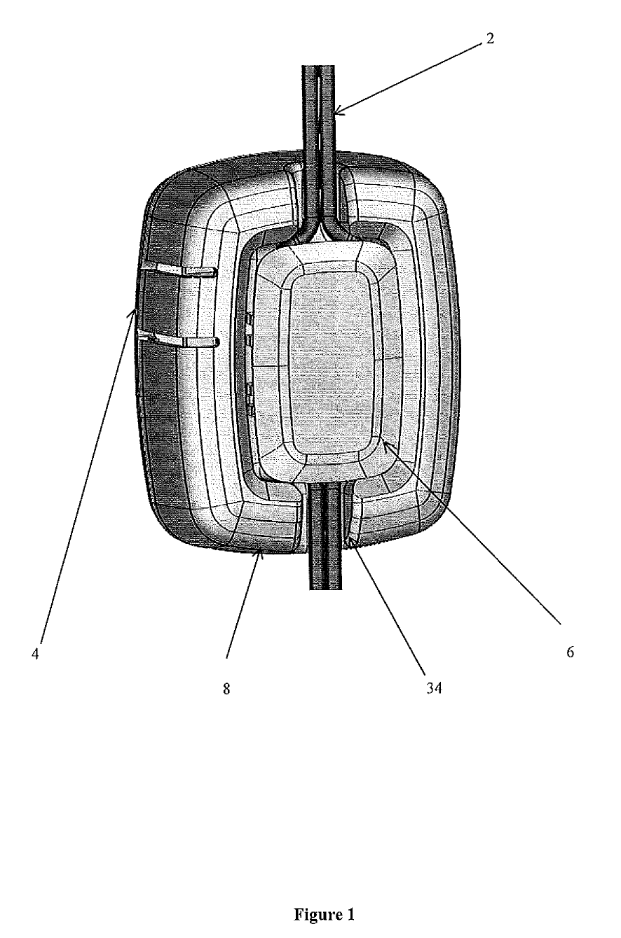

Referring to the drawings, FIG. 1 demonstrates the preferred embodiment of the invention's external housing 8 as installed. The external housing 8 fits underneath the existing garage door wiring 2, which is held in place by the guiding channels 32. The contact penetrating clip 6 snaps into place over the existing garage door wiring 2. The depressible button 4 can be used to operate the garage door manually absent a Bluetooth device.

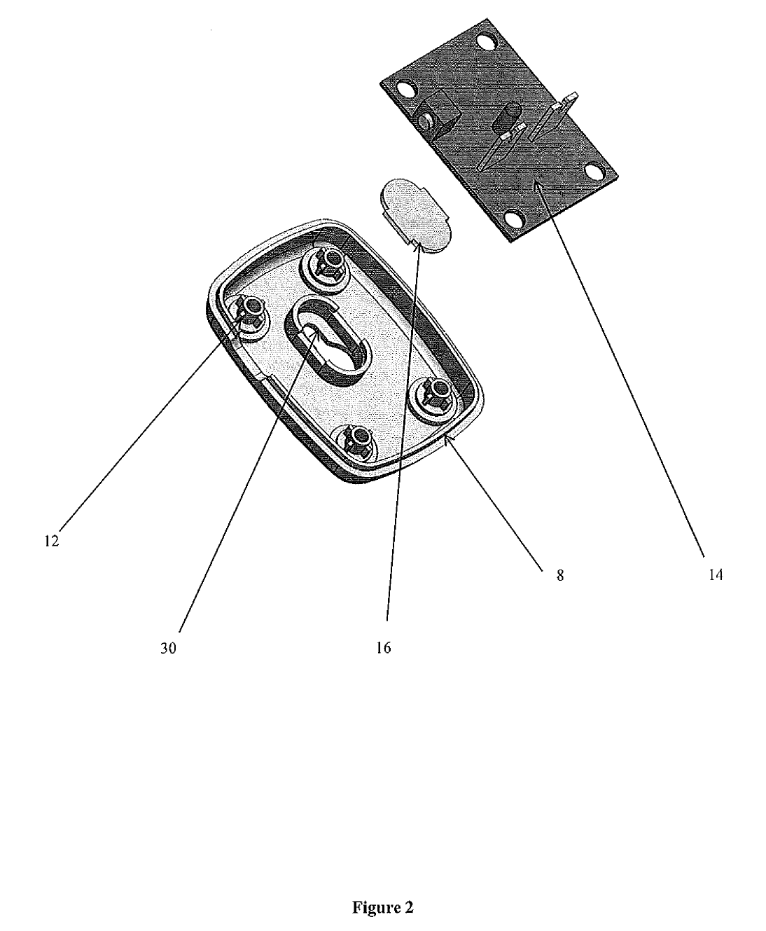

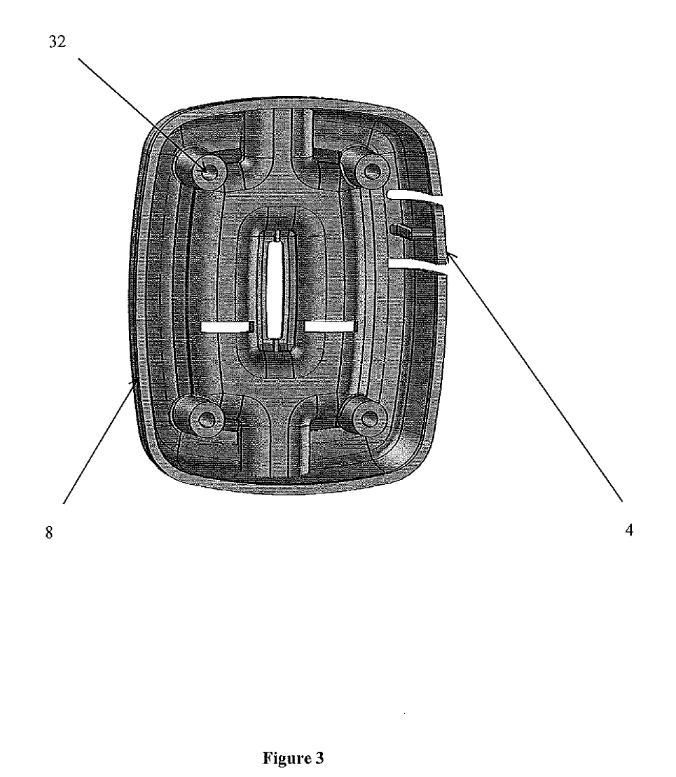

Referring to FIG. 2, the back half of the external housing 8 is visible. The crew mount 30 allows the housing to be securely attached to an existing surface, and the crew mount cover 16 provides additional protection. The printed circuit board (PCB) 14 fits onto the ribbed PCB mounting bosses 12. The upper half of the external housing 8 is shown in FIG. 3, which demonstrates how the two pieces house the PCB 14. The mounting posts 32 join with the ribbed mounting bosses 12 to hold the entire apparatus together in a single unit.

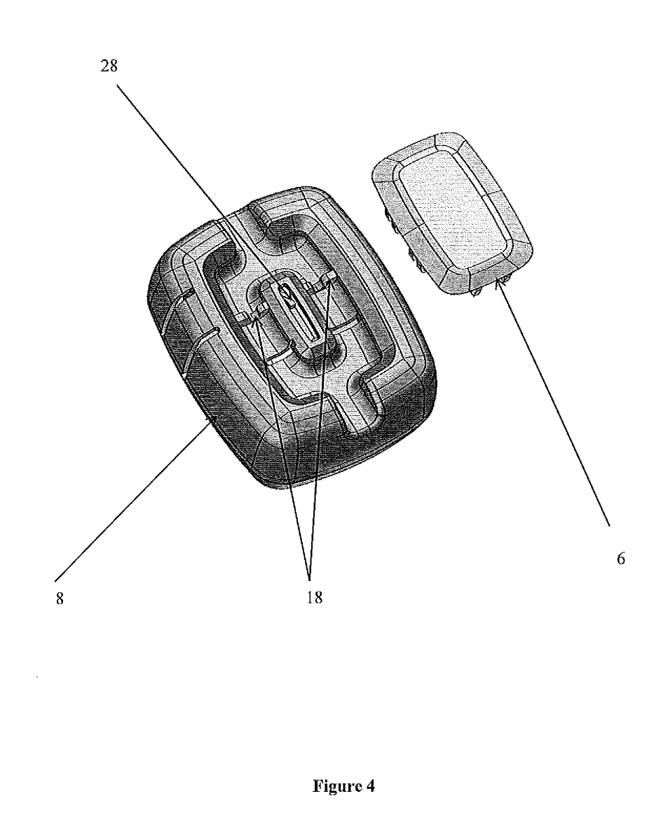

FIG. 4 shows the apparatus as described with both halves of the external housing 8 joined and the PCB 14 contained therein. Here, with the contact penetrating clip 6 removed, one can see the dummy wire posts 18. The dummy wire posts 18 hold the wires in place when placing the contact penetrating clip 6 into place.

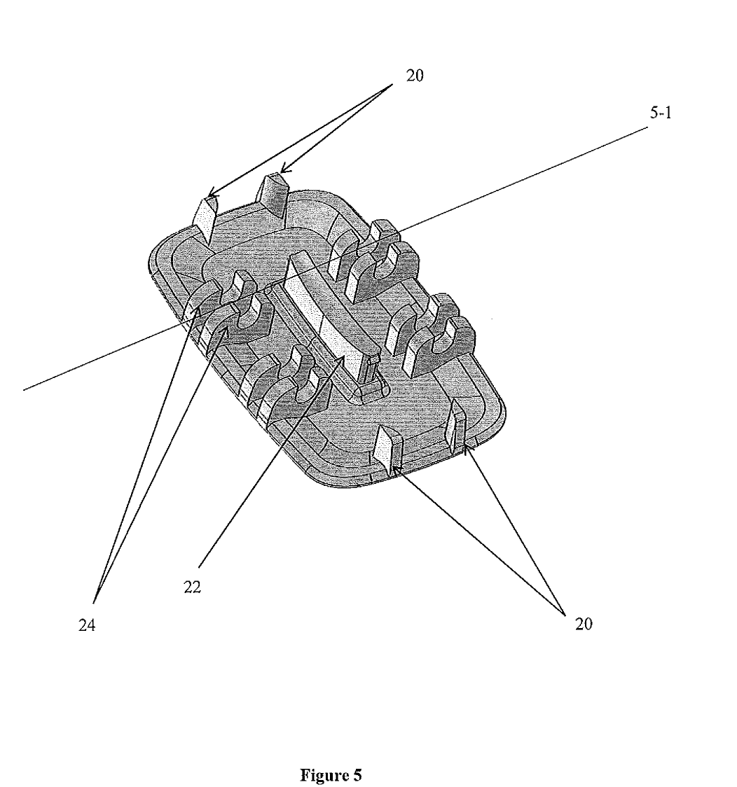

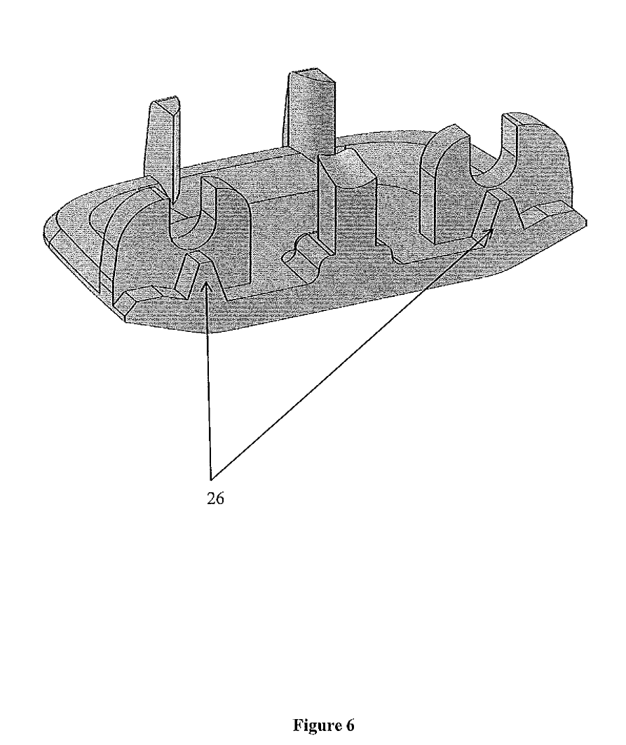

The contact penetrating clip 6 is displayed by FIG. 5. The underside of the contact penetrating clip 6 contains the necessary tools to enable the functionality of the invention. The wire guides 20 help guide the exiting garage door wiring 2 as they enter or exit the external housing. This existing garage door wiring 2 is further secured by wire clips 24. These wire clips 24 hold the wiring in place for depression into the cutting blades 26. FIG. 6 shows a view taken along line 5-1 (FIG. 5) in order to demonstrate the functionality of the cutting blades 26. Once the existing garage door wiring 2 is cut by the cutting blades 26, it allows for the electrical current from the wires to be tapped into.

The method of installation of the invention is achieved by securing the existing garage door wiring 2. Preferably this can be done at eye level. The external housing 8 is placed underneath this wiring. The wiring is placed in the wiring channels 32 and snapped into the dummy wire posts 18. The contact penetrating clip 6 is snapped into place over the existing garage door wiring 2. The invention is now installed as preferred and ready to interact with the designated or adapted Bluetooth device.

What is claimed is:

1. A wireless radio frequency switch controller comprising:
a printed circuit board;
an external housing having ribbed mounting bosses containing the printed circuit board; and
a contact penetrating clip attached to the external housing.

2. The wireless radio frequency switch controller of claim 1 further comprising a depressible button formed as part of the external housing.

3. The wireless radio frequency switch controller of claim 1 further comprising a single status light emitting diode.

4. The wireless radio frequency switch controller of claim 1 wherein a low energy Bluetooth device communicates with the printed circuit board.

5. The wireless radio frequency switch controller of claim 1 wherein a motor voltage change over a low volt direct current wiring of an existing garage door is monitored.

6. The wireless radio frequency switch controller of claim 1 wherein an accelerometer is placed on the existing garage door apparatus.

7. The wireless radio frequency switch controller of claim 1 further comprising an internal real time clock.

8. The wireless radio frequency switch controller of claim 7 wherein the internal real time clock automatically changes the position of the garage door.

9. The wireless radio frequency switch controller of claim 8 wherein the position of the garage door is electronically recorded.

10. The wireless radio frequency switch controller of claim 7 wherein time and date stamps are applied to any garage door activity.

11. The wireless radio frequency switch controller of claim 1 wherein the polarity of the existing garage door wiring comprising the signal and ground is determined automatically by the built-in software.

12. A method of using a wireless radio frequency switch controller, comprising the steps of:
attaching an external housing to existing garage door wiring;
depressing a contact penetrating clip to the garage door wiring; and
sending an ISM wireless radio spectrum signal to the wireless radio frequency switch.

13. The method of claim 12 wherein the ISM wireless radio spectrum signal is a Bluetooth low energy, ANT, or Zigbee protocol signal implementing 128-bit encryption security.

14. The method of claim 12 wherein the wireless radio frequency switch controller is attached to a thermostat, security system, doorbell, motion detector, smoke detector, light detector, carbon monoxide detector, or natural gas detector.

15. The method of claim 14 further comprising sending an alert to a wireless receiver.
